(19) United States
(12) Patent Application Publication
(10) Pub. No.: US 2021/0279308 A1
(43) Pub. Date: Sep. 9, 2021

(54) SECURITY SYSTEM AND METHOD RANDOMLY OMITTING KEY

(71) Applicant: YongSung KIM, Incheon (KR)

(72) Inventor: YongSung KIM, Incheon (KR)

(21) Appl. No.: 16/860,258

(22) Filed: Apr. 28, 2020

(30) Foreign Application Priority Data
Mar. 5, 2020 (KR) 10-2020-0027828

(51) Int. Cl. G06F 21/31

(52) U.S. Cl. CPC G06F 21/31

(57) ABSTRACT

A password security system in which at least one randomly designated key is omitted when entering a password comprising: a storage part for storing a password set consisting of a plurality of keys; a control part randomly generating at least one key to be omitted among the password set; a display part that displays a position of the key that is omitted or a flow of time; an input part where the rest of the password set is entered except for the key to be omitted; and an unlocking part that locks or unlocks the password security system whether the entered password matches.

### BACKGROUND OF THE INVENTION

### 1. Field of the Invention

The present invention relates to a security system omitting at least one key randomly, and more particularly, relates to a password security system in which at least one designated key is randomly omitted when entering a password.

### 2. Description of the Related Art

A security system is a system that protects and prevents unauthorized persons from accessing files or devices, etc. In order for an authorized person to access, a password set by the user must be entered.

Since door locks on entrance doors or ATMs in banks use relatively simple keypads to enter passwords, passwords can be easily exposed by installing a hidden camera or using fingerprints or scratches on the keypad.

As a conventional technique of a password security system, a technique for guiding the input of a random character when entering a password has been proposed, but it cannot be applied to a door lock or ATM machine with a simple keypad as an additional authentication means.

### SUMMARY OF THE INVENTION

In order to solve the above technical problems, the present invention is to provide a simple and high security by randomly reducing the number of password input digits rather than increasing the number of digits that are difficult to remember.

A password security system according to the present invention for solving the above problems comprising: a storage part for storing a set password; a control part randomly generating at least one password key to be omitted among the stored passwords; a display part that displays a position of the password that is omitted or a flow of time; an input part in which the rest of the password is input and an unlocking part for locking or unlocking the security system according to whether the input password is matched, except for the password designated as an omission key.

The password security system features the omission of at least one randomly designated key.

The display part features that it is any one or a combination of two or more of the hearing means or visual means.

The display part is an LCD display or an LED display.

The display part is a speaker or a buzzer.

The password features that a time difference between input events is included.

The time difference between input events is either a touching lag that is a time between touch events that touch a key, or a pushing lag that is a continuous time difference between a touch and a release on a key.

The time difference between the input events is characterized by displaying a time flow by visual or auditory means.

The time flow is provided even when generating a password, and also provided when a password is input for unlocking.

The time difference between input events is characterized by being an integer truncated less than a second.

According to another embodiment of the present invention, a password security method comprising the steps of: storing a set password in a storage part; randomly generating at least one key to be omitted from the stored password set in the control part; displaying a position of a key or a flow of time that is omitted in the display part; entering the rest of the password except for the key designated as an omitted key in the input part and locking or unlocking the security system according to whether the password entered in the unlocking part matches.

The password set may further include a time difference between input events.

### BRIEF DISCRIPTION OF THE DRAWINGS

FIG. 1 is a block diagram of a password security system according to the present invention.

FIG. 2 is an exemplary view of a method for displaying an omission key according to the present invention, wherein (a) is expressed by voice, (b) is displayed by a display screen, and (c) is indicated by an LED.

FIG. 3 is a flow chart of a method for omitting at least one key in accordance with the present invention.

FIG. 4 is a flow chart of a security method using a touching lag as a password for omitting at least one key method according to the present invention.

FIG. 5 is a flow chart of a security method using a pushing lag as a password for omitting at least one key method according to the present invention.

FIG. 6 is an embodiment in which the input window flashes to indicate a flow of time, where (a) is highlighted and (b) is off.

FIG. 7 is an embodiment showing a time flow by position or number, (a) is showing time flow by number, and (b) is showing time flow by number.

FIG. 8 shows a time flow on the number of a display, where (a) is an initial state, (b) is 1 second, and (c) is 2 second in accordance with the present invention.

FIG. 9 is an embodiment of a door lock of a password consisting only of numbers.

FIG. 10 is an embodiment of determining whether a user is a legitimate user in the password input step (a) is a 3×4 keypad, and (b) is a straight keypad.

### DETAILED DESCRIPTION OF THE PREFERED EMBODIMENTS

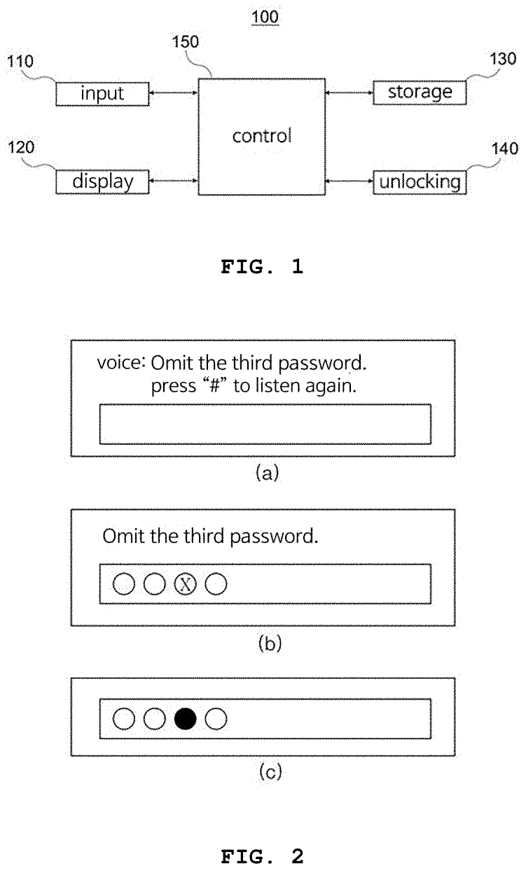

FIG. 1 is a block diagram of a security system 100 according to the present invention. The security system includes input part 110 for entering keys to create or cancel a password, storage part 120 to store the generated password, a display part 130 that display a position of a key that is omitted at random, unlocking part 140 that is locked or unlocked depending on whether the password matches, and a control part 150 that controls each configuration and that determines whether a randomly entered password matches a stored password.

The password is preferably composed of at least four digits including numbers, letters, or special characters, and is stored in the storage part 130 through the input part 110. If the input part is a simple keypad, the password can consist only of numbers.

The input part 110 may be a keyboard, a touch screen, a keypad, or a mouse as a means for inputting keys to generate a password or unlock it.

The display part 120 may be displayed by auditory or visual means for displaying a designated position of an omitted key. Hearing can be expressed by speakers, buzzers, etc., and visual methods can be displayed by letters or figures on the screen, and by on/off or flashing of LEDs. When displaying a flow of time, the display part displays the function of the timer in an auditory or visual manner.

The unlocking part 140 may lock or unlock the security system at a command of the control part. In the case of an access device, the lock is released, and in the case of an ATM, the account is accessed, and in the case of the Internet, the account is accessed.

The control part 150 generates a password, stores it in the storage part, randomly generates a position to be omitted of the password, transmits it to the display part, determines whether the omitted password matches the stored password, and controls the operation of the unlocking part.

The position of the omitted password is specified as at least one of the entire passwords, and is randomly specified each time it is entered.

For example, if a permutation of the keys constituting the password consists of 8 keys, such as ‘abcd1234’, the number of omitted keys and the number of password cases according to the position are as follows.

If the number of keys to be omitted is one, the random number generated is 8 such as ‘bcd1234, acd1234, . . . , abcd123’ and so on. The number of cases in which one key is selected from 8keys is ₈C₁=8. When the number of keys to be omitted is two, the number of cases is ₈C₂=28, the number of cases is ₈C₃=56 for 3, and the number of cases is ₈C₄=70 for 4, and the password can be derived in many cases.

In a random omitted key security system, even if the password input process is recorded by a camera or the like, the omitted password cannot be known, so that the true password cannot be known. In order to unlock the random omitted key security system with only some of the passwords found, it is impossible to enter the security system easily, because the number of cases that are omitted is different each time you enter.

Access to the security system becomes more difficult if the number of inputs is limited and the unlocking operation is impossible after a predetermined number of times.

FIG. 2 is an example of a display part that displays a designated position of an omission key, and is expressed by an auditory or visual method. FIG. 2(a) shows a position of a key that is omitted by voice through the speaker, FIG. 2(b) shows a position of a key that is omitted by the display, and FIG. 2(c) is an example of displaying the LED light emission.

As a case where the third position of the password is designated as an omission key, FIG. 2(a) can be applied to an ATM with a speaker, a smartphone, and a door lock. Through the speaker, “Please enter a password omitting the third password. To listen again, press the # button.” is guided. The password entered according to the voice instruction is ‘abd1234’.

FIG. 2(b) is displayed as ⊗ so that the digit of the omitted key is not entered in the input field with the message “Please enter a password omitting the third password” as a text on the screen. The password entered according to this instruction is also ‘abd1234’.

FIG. 2(c) may indicate that the LED corresponding to an omitted position is blinking or the LED is turned off only at an omitted key.

The display means of the omitted key may be provided in plural, such as voice and vision, and a user may select one method in consideration of the surrounding environment.

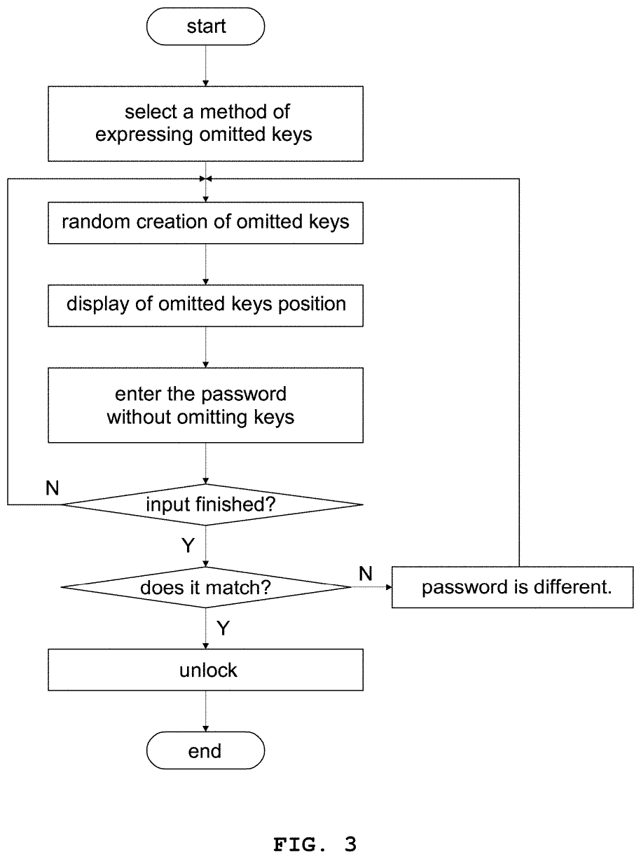

FIG. 3 is a flow chart of a method for omitting at least one key in accordance with the present invention. When there are multiple expression means, all of them may be used or one may be selected.

The omitted key is randomly generated by the control part. The position of an omitted key is displayed by an auditory or visual method on the display part and the password is entered omitting randomly designated key in the input part. If input is not finished for a certain period of time, start again from the beginning. When the password is entered, check if it matches the password except for the omitted key from the password stored in the storage part, and if it matches, the security system is unlocked.

The present invention can enhance security by using a time difference between input events as a password. The event is an action that is input to the input part, such as pressing a keypad or touching a screen. The input events include a touch event that is touched to press a key and a release event that ends contact.

The time difference between the input events is called a touching lag which is the time between the release event and the next touch event. A continuous time difference between the touch event and the release event is called a pushing lag. The touching lag may be a time interval between the touch and the next touch, and the pushing lag may be a time duration when the key is held down.

1) Touching lag password

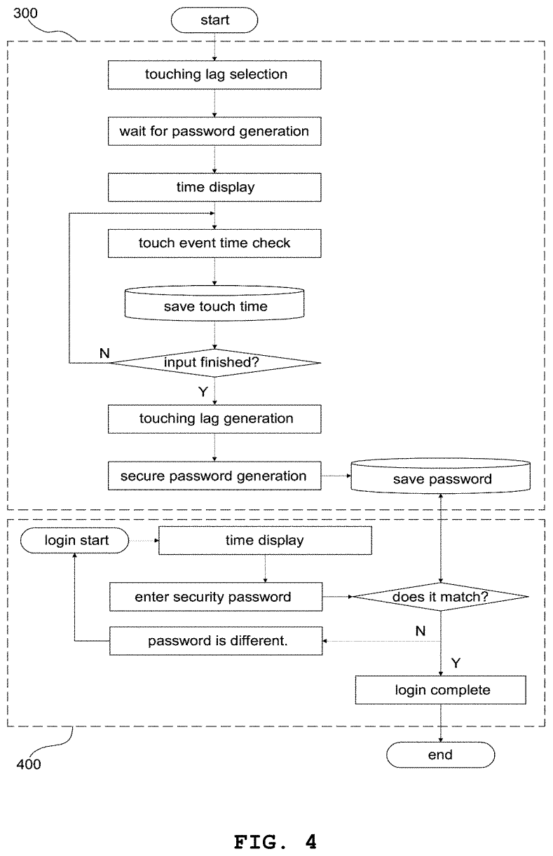

FIG. 4 is a flow chart of a method of generating and storing a touching lag as a password among time differences between keys sequentially input according to the present invention, and releasing a lock in comparison with the input password.

A method 300 of generating a secure password including a touching lag comprises steps of: selecting a touching lag among a touching lag and a pushing lag; waiting in an input window activated to generate a password; selecting and operating a time display means; checking a time of a touch event, storing the time of the checked touch event; checking that all time of the touch event has been input; and generating and storing a password by sequentially combining the generated permutations of the touching lag and the permutations of the keys.

An unlocking method 400 of the touching lag security system selects and operates a time display means, enters a security password, compares the input password with the stored security password to determine whether it matches, and unlocks the system if it matches. If it does not match, directing a user to log in again.

The following describes the ‘abcd’ password and the corresponding the touching lag ‘1020’ password generation as an example.

In the touching lag permutation ‘1020’ each number is a fraction of a decimal point in seconds. A time difference is measured as an integer value by truncating less than a second. The touching lag ‘1’ means that the touching time difference is 1 second or more and less than 2 seconds.

The relationship between ‘1, 0, 2, 0’ which means the time difference between neighboring touch events and a key sequence ‘abcd’, is as follows.

The first number ‘1’ means that the time difference from the time when the password input window is activated and waiting for input to the time when the first key ‘a’ is touched is 1 second or more and less than 2 seconds.

The second number ‘0’ means that the time difference from the time when the first key ‘a’ is touched to the time when the second key ‘b’ is touched is less than 1 second.

The third number ‘2’ means that the time difference from the time when the second key ‘b’ is touched to the time when the third key ‘c’ is touched is 2 seconds or more and less than 3 seconds.

The fourth number ‘0’ means that the time difference from the time when the third key ‘c’ is touched to the time when the fourth key ‘d’ is touched is less than 1 second.

In the process of generating the touching lag, which is the time difference between touch events, the time display means is activated as soon as the password input window is activated, and the time elapses starting at ‘0’.

When the first key ‘a’ is input from the time ‘1’ appears to the time ‘2’ appears in the time display means, the time display means starts at ‘0’ again and displays the time elapsed, and the first touching lag ‘1’ is generated and stored.

If the second key ‘b’ is input until ‘1’ appears in the time display means, the time display means starts at ‘0’ again and displays the time course, and the second touching lag ‘0’ is generated and stored.

When the third key ‘c’ is input from the time ‘2’ appears in the time display means until ‘3’ appears, the time display means starts at ‘0’ again and displays the time-lapse, and the third touching lag ‘2’ is generated and stored. When the fourth key ‘d’ is input until ‘1’ appears in the time display means, the time display means starts at ‘0’ again and displays the time-lapse, and the fourth touching lag ‘0’ is generated and stored.

When all of the touching lags ‘1, 0, 2, and 0’ are generated and stored, the sequence ‘1020’ of the generated touching lag and the sequence of keys ‘abcd’ are sequentially combined and stored as a security password.

For example, a security password may be ‘a1b0c2d0’ or ‘abcd1020’, and such a combination method may be determined by a user.

As a permutation of the key, the permutation ‘abcd’ of alphabetic characters is illustrated, but the key may include numbers, letters and special characters, and the number of digits may be increased.

Unlocking of a combination of an omitted key and a touching lag causes the time difference generated by the omitted key to be omitted. For example, if a password is ‘abcd’ and the time difference is ‘1020’, when ‘c’ becomes the omitted key, the touching lag ‘2’ is also omitted.

Since a password according to the present invention can be used in combination with a password that does not include a time difference between the omitted key, a password without the omitted key, and a password that includes the omitted key and the time difference, the number of cases increases to strengthen the security system such as hacking prevention.

2) Pushing lag

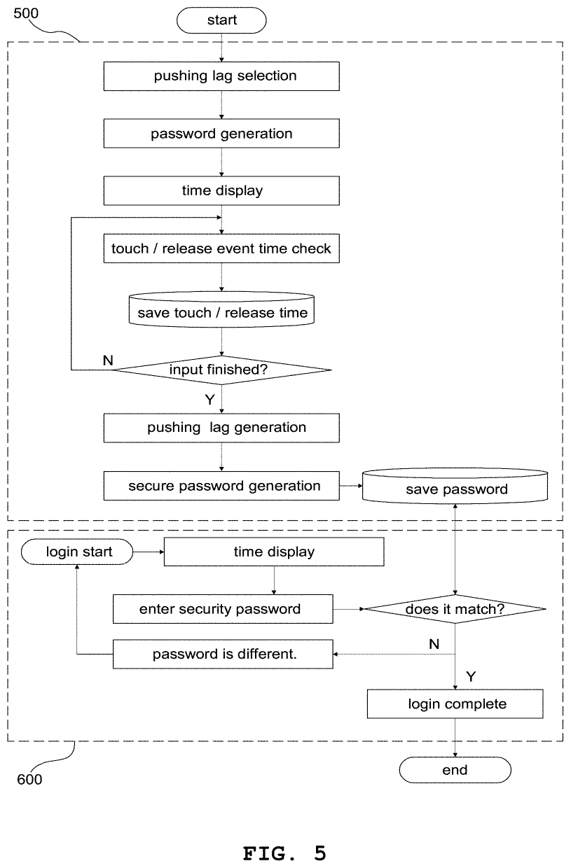

FIG. 5 is a flow chart of a method of generating and storing a pushing lag as a password among time differences between keys sequentially input according to the present invention, and releasing a lock in comparison with the input password.

A method 500 for generating a secure password including a pushing lag comprises steps of: selecting a pushing lag among a touching lag and a pushing lag; waiting in an input window activated for password generation; selecting and operating a time display means; checking the time of a touch event and a release event, storing the time of the checked touch event and the release event; confirming that the time of all touch events and release events has been input; storing and canceling neighboring touch events; generating a pushing password that cuts less than a second from the time of the event; and sequentially generating and storing the security password by sequentially combining a generated permutation and a permutation of keys.

An unlocking method 600 of the touching lag security system comprises the steps of: selecting and operating a time display means; inputting a security password; comparing the entered password with the stored security password to determine whether it matches; and unlocking if it matches. If it does not match, directing a user to log in again. The pushing lag when the permutation of the key is ‘abcd’ and the permutation of the time difference is ‘1020’ is as follows.

In the permutation of the entire pushing lag ‘1020’ each number is a fraction of the decimal point in seconds. The number ‘1’ means that the time difference is 1 second or more and less than 2 seconds. The time difference is measured as an integer value by truncating less than a second. The time difference between the touch event and the release event, that is, the pressing time corresponds to ‘1, 0, 2, 0’.

The first number ‘1’ means that, after the password input window is activated, the time difference from the time when the first key ‘a’ is touched and pressed to the time when the end is pressed is less than 2 seconds.

The second number ‘0’ means that the time difference from the time when the second key ‘b’ is touched and pressed to the time when the key is pressed is less than 1 second.

The third number ‘2’ means that the time difference from the time when the third key is touched by pressing ‘c’ to the time when the pressing is finished is less than 2 seconds and less than 3 seconds.

The fourth number ‘0’ means that the time difference from the time when the fourth key ‘d’ is touched to the time when the key is pressed is less than 1 second.

In the process of generating the pushing lag, which is a time difference between a touch event and a release event, when an input means is a mouse, a time display means is activated as soon as the mouse is placed in the password input window and waits.

The moment the first key ‘a’ is pushed after the input window is activated, the time display means starts at ‘0’ again and displays the time-lapse, and when the end is pressed from the time ‘1’ appears in the time display means until ‘2’ appears, the first pushing lag ‘1’ is generated and stored.

At the moment when the second key ‘b’ is pushed in the input window, the time display means starts at ‘0’ again and displays the time-lapse, and when pressing is finished until ‘1’ appears in a timer, the second pushing lag ‘0’ is generated and stored.

At the moment when the third key ‘c’ is pushed in the input window, the time display means starts at ‘0’ again and displays the time-lapse, and when the end is pressed from the time ‘2’ appears in the time display means until ‘3’ appears, the third pushing lag ‘2’ is generated and stored.

At the moment when the fourth key ‘d’ is pushed in the input window, the time display means starts at ‘0’ again and displays the time-lapse, and when pressing is finished until ‘1’ appears in the time display means, a fourth pushing lag ‘0’ is generated and stored.

The password generated as described above is stored in the storage part and serves as a criterion for determining whether or not a user matches the password entered when unlocking. The password input for unlocking is entered in the same way as when the password is generated, and it is determined whether it matches the stored password.

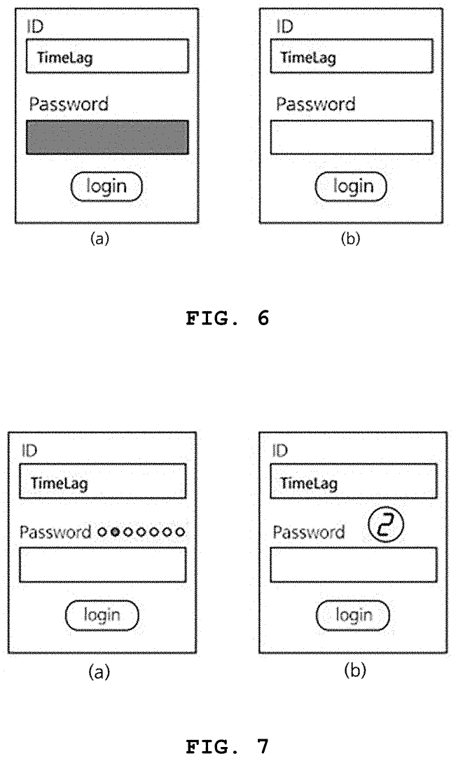

As shown in FIGS. 6 to 8, a time display means of the display part that informs a time flow of a touching lag or a pushing lag may inform a user of the time flow in seconds in various ways in a visual or auditory manner.

As illustrated in FIG. 6, the time flow can be displayed by flashing the password input window every second, where (a) is highlighted and (b) is off.

FIG. 7 shows a flow of time by position or number, and (a) denotes the flow of time by the number, which means that 2 seconds elapse after passing the first, and (b) denotes the flow of time by the number.

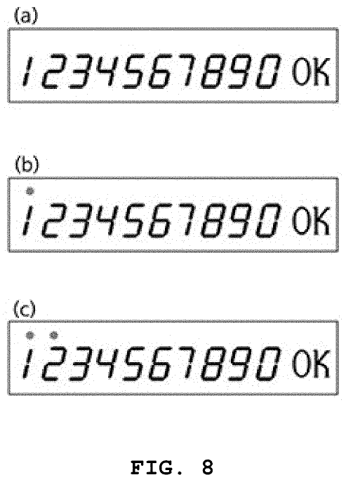

FIG. 8 is an example of a car door lock in which the password is composed only of numbers, and may indicate a time flow on the number of the display. (a) shows an initial screen. (b) shows an elapse of 1 second, and (c) shows an elapse of 2 seconds.

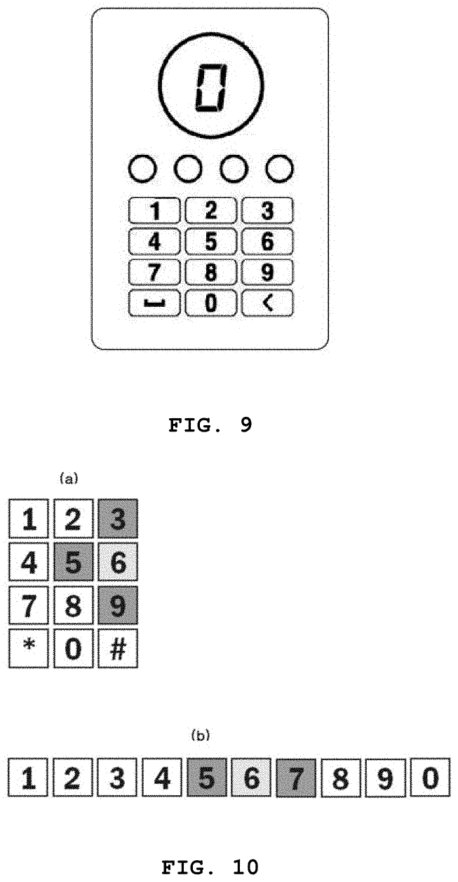

FIG. 9 is an example of a door lock of a password consisting only of numbers, which may be displayed as a digital number on a predetermined keypad surface or may indicate an elapse of time by lighting the LED.

The present invention can add a method of distinguishing a random input of a person who does not know the password and a true number input as a method of improving security.

Among the keys constituting the password, a specific key is randomly selected in a singular or plural number and set as an alarm number key. If a key other than the key adjacent to the alarm number key, up and down, left and right, is entered at the position of the key, it is determined that there is a high possibility of an illegal random input attempt. When the number of illegal inputs exceeds a certain number of times, the unlocking process is automatically stopped.

FIG. 10 shows an example of determining whether a user is a legitimate user in a password input step, and is an illustration in which an alarm number key is set to ‘6’.

FIG. 10(a) is a case where the keypad is a 3x4 keypad, and keys adjacent to key ‘6 ’ are ‘3, 5, and 9’. If ‘1, 2, 4, 7, 8, and 0’ except ‘3, 5, and 9’ are entered, it is determined that there is a high possibility that it is an attempt to enter an illegal password.

FIG. 10 (b) is a case of a straight-type keypad. Since the alarm number key ‘6’ and adjacent keys are ‘5 and 7’, If ‘1, 2, 3, 4, 8, 9, and 0’ except ‘5 and 7’ are entered in place of the key ‘6’, it is likely to be an illegal input attempt.

In the case of a keypad with numbers, letters, and special characters, it is possible to determine an input error due to a legitimate input attempt and an attempt to enter a wrong password in the same manner.

An omitted key password according to the present invention is randomly omitted every time a single or a plurality of keys among the keys constituting the password. Even though the same password, the result is different depending on where the omission is made, the number of cases is increased and the security is enhanced. There are many cases since the position of an omitted key is randomly designated each time. Even though it is exposed by a sneak camera, unlocking s system is difficult.

In addition to a security system using an omitted key, a hacking attempt can be prevented by using a time difference between input events as a password.

What is claimed is:

1. A password security system in which at least one randomly designated key is omitted when entering a password comprising:
a storage part for storing a password set consisting of a plurality of keys;
a control part randomly generating at least one key to be omitted among the password set;
a display part that displays a position of the key that is omitted or a flow of time;
an input part where the rest of the password set is entered except for the key to be omitted; and
an unlocking part that locks or unlocks the password security system whether the entered password matches.

2. The password security system according to claim 1, wherein the display part is one or a combination of two or more of auditory or visual means.

3. The password security system according to claim 1, wherein the display part is an LCD display or an LED display.

4. The password security system according to claim 1, wherein the display part is a speaker ora buzzer.

5. The password security system according to claim 1, wherein a time difference between input events is added as the password set.

6. The password security system according to claim 5, wherein the time difference between input events is either a touching lag that is a time difference between touch events that touch keys, or a pushing lag that is a time difference between a touch event and a release event for a key.

7. The password security system according to claim 5, wherein the time difference between input events is to express a time flow by a visual means or an auditory means.

8. The password security system according to claim 7, wherein the time flow is provided even when the password set is generated and also when the password set is input to unlock.

9. The password security system according to claim 5, wherein the time difference between input events is an integer truncated less than a second.

10. A method in which at least one randomly designated key is omitted when entering a password comprising steps of:
storing a password set in a storage part;
randomly generating at least one key to be omitted from the stored password set in the control part;
displaying a position of an omitted key or a flow of time in a display part;
entering the rest of the password set is except for the omitted key; and
unlocking or locking a password security system according to whether the entered password matches.

11. The method according to claim 10, wherein the password set further includes a time difference between input events.
